(19) United States
(12) Patent Application Publication
(10) Pub. No.: US 2026/0116172 A1
(43) Pub. Date: Apr. 30, 2026

(54) ENGINE MOUNT RESTRICTOR BRACKET

(71) Applicant: FCA US LLC, Auburn Hills, MI (US)

(72) Inventors: Vikas N. Sanghavi, Auburn Hills, MI (US); Milind S. Parab, Auburn Hills, MI (US); Divya T. Repalle, Windsor (CA); Meyyappan Valliappan, Auburn Hills, MI (US); Jordi Martinez, Windsor (CA)

(21) Appl. No.: 18/932,947

(22) Filed: Oct. 31, 2024

(51) Int. Cl. B60K 5/12

(52) U.S. Cl. CPC B60K 5/1208; B60K 5/1291

(57) ABSTRACT

An engine mount bracket has a U-shape body with a web and a front and rear leg. The legs includes bores to receive fasteners to secure the bracket to the engine block. The web includes a bore to receive a hydraulic mount shaft. A surface on the bracket receives a body portion of the hydraulic mount to restrict motion of the hydraulic mount.

### FIELD

The present disclosure relates to automotive vehicles and, more particularly, to engines and engine mount brackets.

### BACKGROUND

This section provides background information related to the present disclosure which is not necessarily prior art.

In an automotive vehicle or truck, the engine is mounted by hydraulic mounts. Generally, the hydraulic mounts are on the frame and a bracket or the like is utilized to connect between the engine and the hydraulic mount. In the event of excessive force applied onto the vehicle, loading can occur on the frame. This is due to the fact that when the excessive forces are applied, the engine mount moves along with the force. As the excessive force is applied, various elements such as the engine, steering gear and main frame rails move rearward. While current designs are satisfactory to prevent the movement, designers are always striving to improve the art.

Accordingly, it would be desirable to have an engine bracket that helps to reduce the main frame rail rearward motion which, in turn, delays hydraulic mount motion. Additionally, reducing the steering gear rearward movement is accomplished.

The present disclosure provides an engine mounting bracket that delays the hydraulic mount motion. The present disclosures provides improved control of the frame rearward motion when the excessive force is applied. Additionally, the present disclosure improves mobility specifically noise vibration and harshness performance of the powertrain.

### SUMMARY

This section provides a general summary of the disclosure, and is not a comprehensive disclosure of its full scope or all of its features.

According to a first object of the disclosure, an engine mount bracket comprises a U-shape body with a web and a front and rear leg. The legs include bores to receive fasteners to secure the bracket to the engine block. The web includes a bore to receive a hydraulic mount shaft. A surface on the bracket receives a body portion of the hydraulic mount to restrict motion of the hydraulic mount. The receiving surface is arcuate with the surface spanning the web and the rear leg. A shelf extends from the web and includes the bore to receive the hydraulic shaft. The rear leg extends from the web along a side of the shelf. One or more stoppers project from the mount to stack with the frame. One or more ribs are on the body to improve noise vibration and harshness performance. The rear leg extends farther away from the web body than the front leg.

According to a second object of the disclosure, a vehicle comprises an engine and a frame with at least one hydraulic mount to support the engine. The bracket is coupled between the hydraulic mount and the engine. The bracket comprises a U-shape body having a web and a front and rear leg. The legs include bores to receive fasteners to secure the bracket to the engine block. The web includes a bore to receive a hydraulic mount shaft. A surface on the bracket receives a body portion of the hydraulic mount to restrict motion of the hydraulic mount. The receiving surface is arcuate with the surface spanning the web and the rear leg. A shelf extends from the web and includes the bore to receive the hydro mount shaft. The rear leg extends from the web along a side of the shelf. One or more stoppers project from the mount to stack with the frame. One or more ribs are on the body to improve noise vibration and harshness performance. The rear leg extends farther away from the web body than the front leg.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle frame and engine.

FIG. 2 is a perspective schematic view of the engine mount bracket.

FIG. 3 is a rear perspective view of the engine bracket.

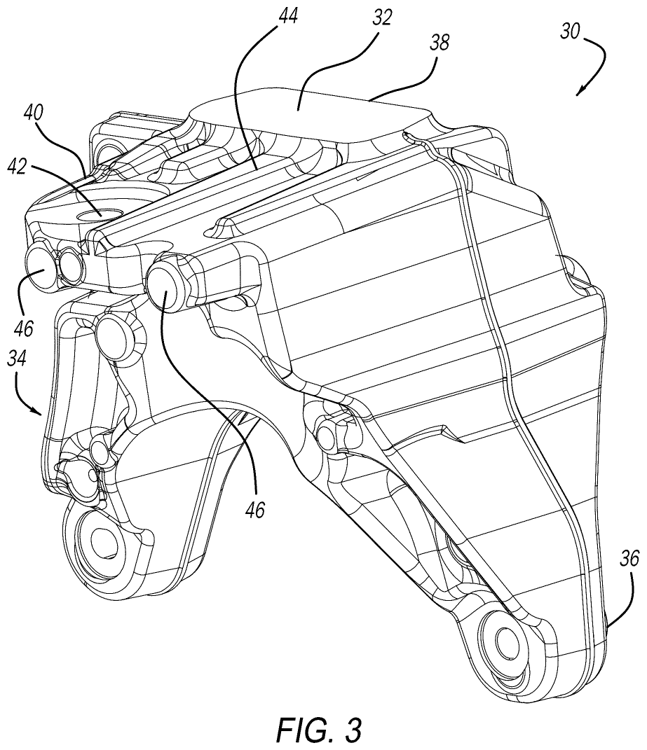

FIG. 4 is a front schematic perspective view of the engine bracket.

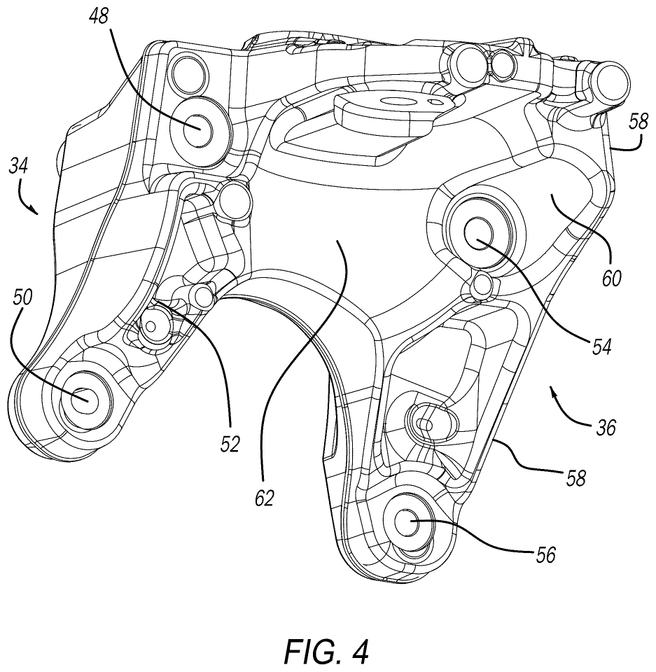

Corresponding reference numerals indicate corresponding parts throughout the several views of the drawings.

### DETAILED DESCRIPTION

Example embodiments will now be described more fully with reference to the accompanying drawings.

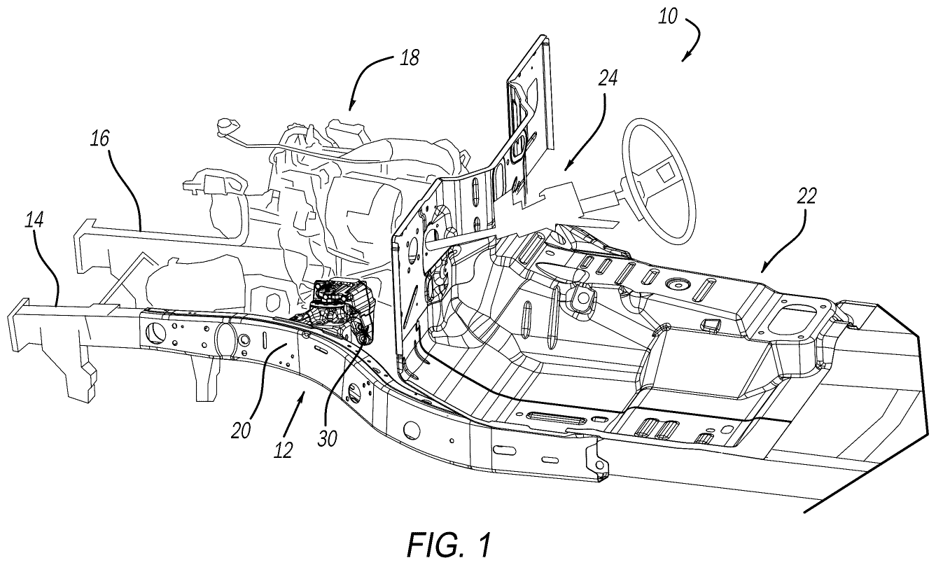

Turning to the figures, a partial schematic view of a vehicle is illustrated and designated with the reference numeral 10. The vehicle 10 includes a frame 12 with rails 14, 16. An engine 18 is mounted to the frame 12 via a hydro mount 20 and an engine mounting bracket 30. The vehicle includes a cab 22 for vehicle occupants. The steering gear 24 extends through the cab as illustrated in FIG. 1.

Generally, the hydro mount 20 is mounted to the frame rails 14, 16 by a bracket 26. The bracket 26 is secured with the rails 14, 16 (only rail 14 illustrated here). The hydro mount 20 has an overall cylindrical shape and includes a mounting shaft 28 that extends into a bore in the engine mounting bracket 30.

The engine mount 30 has an overall U-shape and includes a web 32 with a front leg 34 and a rear leg 36. The web 32 includes a body portion 38 and an extending shelf 40. The shelf 40 includes a bore 42 to receive the hydro mount shaft 28. Also, the shelf 40 includes one or more reinforcement ribs 44 that enhance performance. Specifically, the reinforcement ribs 44 improve the noise vibration and harshness in the vehicle. At least one stopper 46 extend from the shelf 40. The stoppers 46 (two of which are illustrated) provide stacking with the frame 12.

The first leg 34 includes bore 48, 50 that receive fasteners to secure the bracket 30 with the engine 18. Preferably the bolts pass through the bores 48, 50 and secure with an engine block. The front leg 34 also includes an impression 52 to enhance the reinforcement of the front leg 34.

The rear leg 36 includes bores 54, 56. The bores 54, 56 receive fasteners to secure the bracket 30 with the engine block. Additionally, the rear leg 36 includes an impression 58 to provide reinforcement to the rear leg 36.

The rear leg 36 includes a boss 58 that extends adjacent the shelf 42. The boss 58 extends a desired distance to provide a countersink 60 for the bore 54. The countersink 60 has an arcuate surface.

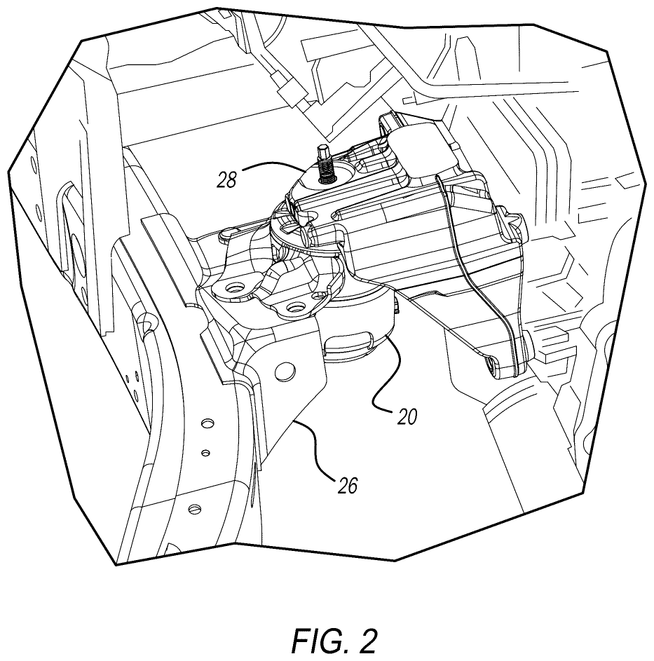

A hydraulic mount receiving surface 62 is formed in the web body 38 and the rear leg boss 58. The receiving surface 62 has an arcuate surface to position the bracket 30 adjacent the hydro mount 20 as illustrated in FIG. 2. This enables the hydro mount to be positioned within the bracket 30.

Thus, as an excessive force is applied onto the vehicle, the hydro mount movement is restricted by the receiving surface 62 and countersink 54. Thus, as the hydro mount moves within the bracket 30, the shaft 28 is deformed in the shelf bore 40 and the hydro mount moves along the surface 62 into the countersink portion 60. This slows the movement of the hydro mount 20 as the force is applied to the vehicle. Also, as the hydro mount 20 moves, it begins to stack up into the receiving surface 62 and countersink 60 which, in turn, reduces the loading on the occupant cabin. Accordingly, the engine bracket 30 helps to reduce the main frame rails rearward motion in the event of an excessive force. Also, the engine brackets 30 delays the hydro mount motion. Further, the brackets 30 helps to reduce the rearward motion of the steering gear.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An engine mount bracket comprising:
a U-shape body having a web, a front and rear leg, the legs including bores for receiving fasteners to secure the bracket to the engine block;
the web including a bore for receiving a hydro mount shaft; and
a surface on the bracket for receiving a body portion of the hydro mount for restricting motion of the hydraulic mount.

2. The engine mount bracket of claim 1, wherein in the receiving surface is arcuate with the surface spanning the web and the rear leg.

3. The engine mount bracket of claim 1, wherein a shelf extends from the web and includes the bore for receiving the hydro mount shaft.

4. The engine mount bracket of claim 3, wherein the rear leg extends from the web along a side of the shelf.

5. The engine mount bracket of claim 1, wherein one or more stoppers project from the mount for stacking with a frame.

6. The engine mount bracket of claim 1, wherein one more ribs are on the body to improve noise, vibration and harshness performance.

7. The engine mount bracket of claim 1, wherein the rear leg extends farther away from the web body than the front leg.

8. A vehicle comprising:
an engine; and
a frame with at least one hydro mount for supporting the engine, and a bracket coupling the hydraulic mount and the engine;
the bracket comprising:
a U-shape body having a web, a front and rear leg, the legs including bores for receiving fasteners to secure the bracket to the engine block;
the web including a bore for receiving a hydro mount shaft; and
a surface on the bracket for receiving a body portion of the hydro mount for restricting motion of the hydro mount.

9. The vehicle of claim 8, wherein in the receiving surface is arcuate with the surface spanning the web and the rear leg.

10. The vehicle of claim 8, wherein a shelf extends from the web and includes the bore for receiving the hydro mount shaft.

11. The vehicle of claim 10, wherein the rear leg extends from the web along a side of the shelf.

12. The vehicle of claim 8, wherein one or more stoppers project from the mount for stacking with a frame.

13. The vehicle of claim 8, wherein one more ribs are on the body to improve noise, vibration and harshness performance.

14. The vehicle of claim 8, wherein the rear leg extends farther away from the web body than the front leg.
